(19) United States
(12) Patent Application Publication
(10) Pub. No.: US 2005/0154660 A1
(43) Pub. Date: Jul. 14, 2005

(54) Cash-settled commodity futures contracts

(75) Inventors: Frederick Wienert Sturm, Chicago, IL (US); Ingrid Mele, Chicago, IL (US); Eugene Rene Mueller, Libertyville, IL (US)

Correspondence Address: FOLEY & LARDNER, 321 NORTH CLARK STREET, SUITE 2800, CHICAGO, IL, 60610-4764, US

(73) Assignee: Chicago Board of Trade

(21) Appl. No.: 10/756,087

(22) Filed: Jan. 13, 2004

(51) Int. Cl. G06F 17/60

(52) U.S. Cl. 705/35

(57) ABSTRACT

A futures contract in accordance with the principles of the present invention is a cash-settled correspondent to a physical delivery commodity futures contract that mirrors a physical delivery mechanism utilized to settle the corresponding physical-delivery commodity futures contract. A futures contract of the present invention references a basket of deliverable-grade commodities corresponding to a deliverable basket for a corresponding physical-delivery commodity futures contract. A futures contract of the present invention obeys the same schedule for last trading day and expiration as a corresponding physical delivery commodity futures contract. A futures contract of the present invention has tick sizes that may or may not differ from a corresponding physical delivery commodity futures contract. A futures contract of the present invention converges to a final settlement value equal to a conversion-factor-weighted price of whichever member of the deliverable basket is cheapest to deliver into the corresponding physical delivery commodity futures contract.

### FIELD OF THE INVENTION

The present invention relates generally to commodities and futures contracts based thereon.

### BACKGROUND OF THE INVENTION

A variety of different types of contracts are traded on various commodity exchanges and other markets throughout the world. A cash contract is a sales agreement for either immediate or deferred delivery of the actual commodity. An option is a contract that conveys the right, but not the obligation, to buy or sell a particular commodity or futures contract on a commodity at a certain price for a limited time. A call option is an option that gives the buyer the right, but not the obligation, to purchase the underlying commodity or futures contract at a certain price (known as the strike price) on or before the expiration date. A put option is an option that gives the option buyer the right, but not the obligation, to sell the underlying commodity or futures contract at the strike price on or before the expiration date.

A futures contract is a legally binding agreement, typically entered into on or pursuant to the rules of a commodity exchange, to buy or sell a commodity (which may be a financial instrument) sometime in the future. A commodity is generally an article of commerce or a product that can be used for commerce. In a narrow sense not intended for use herein, futures and options contracts for commodities are products traded on a formally organized commodity exchange. Unlike cash commercial contracts, futures contracts very rarely result in delivery, because most are liquidated by offsetting positions prior to expiration. The types of commodities commonly include: agricultural products such as corn, soybeans, and wheat; precious metals such as gold; fuels such as petroleum; foreign currencies such as the Euro; financial instruments such as U.S. Treasury securities; financial indexes such as the Standard & Poor's 500 stock index; and bond indexes, to name a few.

A bond is a debt instrument issued for a period of more than one year with the purpose of raising capital by borrowing. A government bond is a debt instrument issued by a government. For example, the United States government issues bonds. As an additional example, the government of the Federal Republic of Germany issues bonds.

It is known in the art to issue futures contracts utilizing government bonds as the underlying commodity. An example of a government bond futures contract is the Schatz futures contract offered by the London International Financial Futures and Options Exchange (LIFFE), which is owned by Euronext, Euronext N.V., Beursplein 5, 1012 JW Amsterdam, The Netherlands, and with LIFFE located at Cannon Bridge House, 1 Cousin Lane, London EC4R 3XX, United Kingdom. The Schatz futures contract is based on Bundesschatzanweisungen (Schatz), short-term federal debt instruments issued by the Federal Republic of Germany.

The characteristics of these Schatz futures include physical delivery, on the tenth calendar day of the delivery month (two business days after the last day of trading in an expiring Schatz futures contract), of eligible Bund, Bobl, and Schatz issues with remaining term to maturity of 1¾ to 2¼ years; a nominal contract value of 200,000 Euros; a 6% coupon unit of trading; contract expiration and delivery in March, June, September, and December such that the nearest three delivery months are available for trading; quotation in price points per contract, with par on the basis of 100 price points; a nominal value of 2,000 Euros per price point (or 200,000 Euros per Schatz futures contract); and a tick size of 0.005 price points, making a tick value of 10 Euros. Significantly, as with many other futures contracts on government bonds the Schatz futures contract is settled by physical delivery.

An additional example of a government bond futures contract is the Bobl futures contract offered by Eurex AG, Neue Börsenstrasse 1, 60487 Frankfurt/Main, Germany. The Bobl futures contract is based on Bundesobligationen (Bobls), medium-term debt instruments issued by the Federal Republic of Germany. The characteristics of these Bobl futures include physical delivery, on the tenth calendar day of the delivery month (two business days after the last day of trading in an expiring Bobl futures contract), of eligible Bund and Bobl issues with remaining term to maturity of 4½ to 5½ years; a nominal contract value of 100,000 Euros; a 6% coupon unit of trading; contract expiration and delivery in March, June, September, and December such that the nearest three delivery months are available for trading; quotation in price points per contract, with par on the basis of 100 price points; a nominal value of 1,000 Euros per price point (or 100,000 Euros per Bobl futures contract); and a tick size of 0.01 price points, making a tick value of 10 Euros. Significantly, as with many other futures contracts on government bonds the Bobl futures contract is settled by physical delivery.

A third example of a government bond futures contract is the Bund futures contract offered by Eurex AG. The Bund futures contract is based on Bundesanleihen (Bunds), long-term debt instruments issued by the Federal Republic of Germany. The characteristics of these Bund futures include physical delivery, on the tenth calendar day of the delivery month (two business days after the last day of trading in an expiring Bund futures contract), of eligible Bund issues with remaining term to maturity of 8½ to 10½ years; a nominal contract value of 100,000 Euros; a 6% coupon unit of trading; contract expiration and delivery in March, June, September, and December such that the nearest three delivery months are available for trading; quotation in price points per contract, with par on the basis of 100 price points; a nominal value of 1,000 Euros per price point (or 100,000 Euros per Bund futures contract); and a tick size of 0.01 price points, making a tick value of 10 Euros. Significantly, as with many other futures contracts on government bonds the Bund futures contract is settled by physical delivery.

Futures contracts that require settlement by physical delivery, such as those exampled above, may not be satisfactory for use in arbitrage in the event of attempts by market participants to effect futures delivery squeezes. Distortions in the prices of both commodity futures contracts and their underlying deliverable commodities frequently arise in the event of futures delivery squeezes. Under the conditions of such squeeze-related price distortion, futures market participants seeking either to make or to take delivery under the terms of a physical delivery commodity futures contract must be concerned about who owns what, rather than the fair-value relationship, based in finance theory, between the commodity futures contract and the corresponding deliverable commodity. As these prior art futures contracts draw towards expiry, fair valuation tends to be eclipsed by concern over securing deliverable commodities, whatever the price.

What would therefore be useful would be a futures contract that will promote arbitrage with physical delivery commodity futures contracts. It further would be useful that such futures mirror the same physical delivery schedule as the corresponding physical delivery commodity futures contract. In addition, what would be useful would be a futures contract that is cash-settled rather than one that entails making or compels taking physical delivery.

### SUMMARY OF THE INVENTION

A futures contract in accordance with the principles of the present invention mirrors the physical delivery schedule of a corresponding physical delivery commodity futures contract. A futures contract in accordance with the principles of the present invention is cash-settled rather than entailing making or compelling taking physical delivery. A futures contract in accordance with the principles of the present invention will promote arbitrage with any corresponding physical delivery commodity futures contract.

A futures contract in accordance with the principles of the present invention enables cash settlement while simultaneously preserving the price dynamics of a physical delivery commodity futures contract. A futures contract in accordance with the principles of the present invention provides the convenience of cash settlement and clarity of cash-futures spreading relationships.

A futures contract in accordance with the principles of the present invention is a cash-settled correspondent to a physical delivery commodity futures contract. A futures contract in accordance with the principles of the present invention mirrors a physical delivery mechanism utilized to settle a corresponding physical delivery commodity futures contract. A futures contract of the present invention references a basket of securities corresponding to the deliverable basket for a corresponding physical delivery commodity futures contract. A futures contract of the present invention obeys the same schedule for last trading day and expiration as a corresponding physical delivery commodity futures contract. A futures contract of the present invention may or may not have tick sizes that differ from a corresponding physical delivery commodity futures contract. A futures contract of the present invention converges to a final settlement value equal to a conversion-factor-weighted price of whichever member of the deliverable basket for a corresponding physical delivery commodity futures contract is cheapest to deliver into the corresponding physical delivery commodity futures contract.

### DETAILED DESCRIPTION OF THE INVENTION

A futures contract in accordance with the principles of the present invention is a cash-settled commodity futures contract that mirrors the physical delivery mechanism that settles a corresponding physical delivery commodity futures contract. A futures contract in accordance with the principles of the present invention references a basket of securities corresponding to, and preferably identical to, the deliverable basket for a corresponding physical delivery commodity futures contract. A futures contract in accordance with the principles of the present invention obeys the same schedule for last trading day and expiration as a corresponding physical delivery commodity futures contract.

Still further, a futures contract in accordance with the principles of the present invention converges to a final settlement value equal to the conversion-factor-weighted price of whichever member of the deliverable basket for a corresponding physical delivery commodity futures contract is cheapest to deliver into the corresponding physical-delivery commodity futures contract; however, it is an advantage of the present invention that in extreme market conditions, as may arise especially in the course of a futures contract delivery squeeze, the price of the futures contract of the present invention and the price of a corresponding physical delivery commodity futures contract may diverge, with the futures contract of the present invention expiring at a price level that is more sensible, in the sense of offering no unresolved cash-futures arbitrage opportunities.

More particularly, in delivery squeezes, the prices of physical-delivery commodity futures contracts have been known to become so distorted that, at contract expiration, one or more members of a contract's deliverable basket may exhibit negative terminal values for the cash-futures basis. If the futures contract were to expire at a value that leaves no such unresolved residual arbitrage opportunities, then exactly one member of the contract's deliverable basket—the cheapest-to-deliver issue—should have a net cash-futures basis equal to zero, and all other members of the basket should have cash-futures basis values that are positive.

Futures contracts in accordance with the principles of the present invention may or may not feature tick sizes that differ from the corresponding physical-delivery futures contract. If futures contracts in accordance with the principles of the present invention do feature tick sizes that differ from a corresponding physical-delivery futures contract, then this results in price dynamics that may differ between the two futures contract over extremely short time intervals. The resultant mismatch in price dynamics at extremely high frequencies generates a steady stream of short-lived arbitrage opportunities.

Futures contracts in accordance with the principles of the present invention may or may not feature trading times that differ from the trading times of the corresponding physical-delivery futures contract. In one embodiment of the present invention, the preferred trading day may reflect a compromise between the advantages and disadvantages of extending the trading day beyond the trading period of any corresponding physical-delivery commodity futures contract. The disadvantages of extending the trading day beyond the trading period of the corresponding physical-delivery commodity futures contract include the reduction in liquidity that occurs after the market closes for the corresponding physical-delivery commodity futures contract. One consequence of this illiquidity is that thin after-hours trading could make a round-the-clock family of futures contracts in accordance with the principles of the present invention vulnerable to manipulation. Still further, the costs and physical burden of staffing that potential users would confront in essaying involvement in an extended trading day for the futures contract in accordance with the principles of the present invention might prove to be excessive for some potential users. If so, then this too would weigh against extending the trading day.

On the other hand, some of the advantages of extending the trading day beyond the trading period of the corresponding physical-delivery commodity futures contract include its usefulness to option traders who frequently must adjust delta hedges on their gamma trades at times that lie outside normal trading hours. In instances where a futures contract in accordance with the principles of the present invention is traded in a market domiciled in a domestic time zone that differs from the foreign time zone in which a corresponding physical-delivery commodity futures contract is traded, a preferred embodiment of the present invention is an effective compromise in which the futures contract of the present invention trading day begins at the same time as the normal opening of the foreign trading day for the corresponding physical-delivery commodity futures contract, and concludes near the normal close of the domestic trading day.

As with the trading day, futures contracts in accordance with the principles of the present invention may or may not feature trade matching methodology that differs from the trade matching methodology of the corresponding physical-delivery futures contract. In one embodiment of the present invention, the trade matching methodology for futures contracts of the present invention reflects an effective compromise, here between first in first out (FIFO) trade matching and pro-rata trade matching. Many market participants perceive FIFO as being the fairest and most convenient matching system for their customers' purposes and view pro rata as flawed by an undue and misplaced emphasis upon sharing of transaction opportunities. However, pro rata trade matching is more likely than FIFO to create the illusion of liquidity, especially in newly introduced futures contracts, by forcing market participants to post outsized bids or offers. In accordance with a preferred embodiment of the present invention, an effective compromise is to utilize a trade matching methodology that mirrors the trade matching methodology of the corresponding physical-delivery commodity futures contract.

Additionally, futures contracts in accordance with the principles of the present invention may or may not feature a pricing source that differs from the pricing source of the corresponding physical-delivery futures contract. With minor exceptions, market participants do not have any firm preferences or biases regarding the pricing source employed in establishing expiration values for futures contracts of the present invention. The reason is that most market participants take care to exit their positions in the corresponding physical-delivery commodity futures contracts before the commencement of the delivery period for those contracts. In practice this suffices for most market participants to avoid the potentially adverse financial impact of delivery squeezes in the corresponding physical-delivery commodity futures contracts.

In accordance with another preferred embodiment of the present invention, Exchange of Futures for Physical (EFP) transactions utilizing futures contracts in accordance with the principles of the present invention are permitted. EFP transactions involve the delivery of physical product from one market participant to another and a concomitant assumption of equal and opposite futures positions by the same participants. By permitting EFP transactions, market participants are provided an alternative avenue of transacting futures contracts in accordance with the principles of the present invention outside the normal trading environment.

Specifically, the settlement price (P) of the present invention is determined in accordance with:
P=Z×(minimum{P₁/c₁ . . . P_{N}/c_{N}}),
where:
Z is the notional value of a futures contract in accordance with the principles of the present invention (the product of the number of contract price points at par and the number of currency units per price point);
N is the number of deliverable commodity grades in the contract's basket;
Pᵢ, i=1 to N, are market prices at the time of contract expiration of each deliverable-grade commodity in the contract's basket; and
cᵢ, i=1 to N, are conversion factors, where each cᵢ scales the corresponding Pᵢ to compensate for any grade, quality, and/or location differentials pertaining to the deliverable grade commodity represented by price Pᵢ, as specified by the futures contract; for example, in the case of a government securities futures contract (either a cash-settled contract in accordance with the principles of the present invention, or a corresponding physical delivery futures contract), cᵢ might be the price at which deliverable government security i yields a given percentage to maturity.

This pricing engine of the present invention appeals to market participants, because it guarantees that the futures contract will expire at the conversion-factor-weighted price of whichever member of the deliverable basket has the highest instantaneous implied financing rate among all issues in the contract's basket. For futures contracts based on government securities, as in the examples cited above, this means that the futures contract will expire at the conversion-factor-weighted price of whichever member of the deliverable basket has the highest instantaneous implied repurchase agreement rate (RP rate). This criterion is more robust than the alternative of converging to the price of whichever member of the deliverable basket exhibits the lowest cash-futures basis at expiration.

In contrast to the price distortions that may arise in delivery squeezes of prior art physical-delivery commodity futures contracts described above, the pricing engine of the present invention assures that a futures contract must expire at a price for which the minimum (notional) cash-futures basis within the contract's basket is zero. This bears two implications: first, futures contracts in accordance with the principles of the present invention offer market participants some measure of protection against gross contract mis-valuation (relative to corresponding cash-market commodity prices) in the event of delivery squeezes. Second, insofar as the final settlement prices of a futures contract of the present invention and its corresponding physical-delivery commodity futures contract may diverge in the event of a delivery squeeze, an arbitrage opportunity will occur.

### EXAMPLE

### Cash-Settled Commodity Futures

The following are non-limiting examples of a cash-settled commodity futures contract in accordance with the present invention.

An example futures contract in accordance with the principles of the present invention utilizes as its corresponding physical-delivery commodity futures contract the Bund futures contract offered by Eurex AG. The corresponding Bund futures contracts offered by Eurex AG have a face value of 100,000 Euros, with a remaining term to maturity of 8½ to 10½ years and a coupon rate of 6% per annum.

The price basis that the example Bund cash-settled futures contracts utilize is points and hundredths of one point, with par on the basis of 100 points and with a point equal to 1,000 Euros. The example Bund cash-settled futures contracts utilize a tick size of 0.2 (20 Euros), which is in contrast to the tick size of 0.01 of the corresponding physical-delivery Bund bond futures contract. The contract months for the example Bund cash-settled futures contracts is the first three consecutive contracts in the March-June-September-December quarterly expiration cycle. The last trading day for the example Bund cash-settled futures contracts is two (2) Frankfurt business days prior to the tenth calendar day of the contract expiration month (or, if the tenth calendar day is not a Frankfurt business day, the Frankfurt business day immediately following the tenth calendar day). The futures contract ceases trading at 12:30 pm Central European time (typically 5:30 am Central United States time) on the last trading day.

The delivery standard is Bunds with remaining term to maturity of 8½ to 10½ years on the tenth calendar day of the contract expiration month (or, if the tenth calendar day is not a Frankfurt business day, the Frankfurt business day immediately following the tenth calendar day), and with a minimum issue amount of 2 billion Euros. The trading hours extend from 8:00 am to 9:15 pm Central Europe time (1:00 am to 2:15 pm Central United States time). Because the corresponding physical-delivery Bund bond futures contract utilizes a FIFO trade matching methodology, the trade matching methodology of the example Bund cash-settled futures contract is FIFO. The example Bund cash-settled futures contract utilizes the FT Interactive Data division of Interactive Data Corporation, 22 Crosby Drive, Bedford, Mass. 01730 as the price source for cash settlement. EFP transactions are permitted.

The final settlement value (S) of the example Bund cash-settled futures contract will be determined as:
S=(1,000 Euros)×(minimum{P₁/c₁ . . . P_{N}/c_{N}}),
where:
N is the number of Bund issues fulfilling the delivery standard;
Pᵢ, i=1 to N, are market prices of each Bund issue fulfilling the delivery standard, where all Pᵢ are quoted in points and hundredths of one point, with par being on the basis of 100 points.
cᵢ, i=1 to N, are conversion factors, where each cᵢ is the price of the corresponding Bund issue, with a one Euro par value, yielding 6.00% to maturity.

A second example futures contract in accordance with the principles of the present invention utilizes as its corresponding physical-delivery commodity futures contract the Bobl futures contract offered by Eurex AG. The corresponding futures contracts offered by Eurex AG are Bobl futures contracts that have a face value of 100,000 Euros, with remaining term to maturity of 4½ to 5½ years and a coupon rate of 6% per annum.

The price basis that the example Bobl cash-settled futures contracts utilize is points and hundredths of one point, with par on the basis of 100 points and with a point equal to 1,000 Euros. The example Bobl cash-settled futures contract utilizes a tick size of 0.2 (20 Euros) which is in contrast to the tick size of 0.01 of the corresponding physical-delivery Bobl futures contract. The contract months for the example Bobl cash-settled futures contracts is the first three consecutive contracts in the March-June-September-December quarterly expiration cycle. The last trading day for the example Bund cash-settled futures contracts is two (2) Frankfurt business days prior to the tenth calendar day of the contract expiration month (or, if the tenth calendar day is not a Frankfurt business day, the Frankfurt business day immediately following the tenth calendar day). The futures contract ceases trading at 12:30 pm Central European time (typically 5:30 am Central United States time) on the last trading day.

The delivery standard is Bunds or Bobls with remaining term to maturity of 4½ to 5½ years on the tenth calendar day of the contract expiration month (or, if the tenth calendar day is not a Frankfurt business day, the Frankfurt business day immediately following the tenth calendar day), and with a minimum issue amount of 2 billion Euros. The trading hours extend from 8:00 am to 9:15 pm Central Europe time (1:00 am to 2:15 pm Central United States time). Because the corresponding physical-delivery futures contracts utilize a FIFO trade matching methodology, the trade matching methodology of the example Bobl cash-settled futures contract is FIFO. The example Bobl cash-settled futures contract utilizes the FT Interactive Data division of Interactive Data Corporation as the price source for cash settlement. EFP transactions are permitted.

The final settlement value (S) of the example Bobl cash-settled futures contract will be determined as:
S=(1,000 Euros)×(minimum{P₁/c₁ . . . P_{N}/c_{N}}),
where:
N is the number of Bund and Bobl issues fulfilling the delivery standard;
Pᵢ, i=1 to N, are market prices of each Bund or Bobl issue fulfilling the delivery standard, where all Pᵢ are quoted in points and hundredths of one point, with par being on the basis of 100 points.
cᵢ, i=1 to N, are conversion factors, where each cᵢ is the price of the corresponding Bund or Bobl issue, with a one Euro par value yielding 6.00% to maturity.

A third example futures contract in accordance with the principles of the present invention utilizes as its corresponding physical-delivery commodity the Schatz bond futures contract offered byLIFFE. The corresponding bond futures contracts offered by LIFFE are Schatz futures contracts that have a face value of 200,000 Euros, with remaining term to maturity of 1¾ to 2¼ years and coupon of 6% per annum.

The price basis the example Schatz cash-settled futures contracts utilize is points and hundredths of one point, with par on the basis of 100 points and with a point equal to 1,000 Euros. The example Schatz cash-settled futures contract utilizes a tick size of 0.005 (5 Euros) which is in contrast to the tick size of 0.01 of the corresponding physical-delivery Schatz futures contract. The reason that the Schatz cash-settled futures contract utilizes a tick size smaller than the tick size of the corresponding physical-delivery commodity is that the Schatz physical-delivery bond futures contract tick size is perceived by the market as too large, thereby affording larger arbitrage opportunities utilizing the example Schatz cash-settled futures contract.

The contract months for the example Schatz cash-settled futures contracts is the first three consecutive contracts in the March-June-September-December quarterly expiration cycle. The last trading day for the example Schatz cash-settled futures contracts is two (2) Frankfurt business days prior to the tenth calendar day of the contract expiration month (or, if the tenth calendar day is not a Frankfurt business day, the Frankfurt business day immediately following the tenth calendar day). The futures contract ceases trading at 12:30 pm Central European time (typically 5:30 am Central United States time) on the last trading day.

The delivery standard is Bunds, Bobls, or Schatz with remaining term to maturity of 1¾ to 2¼ years on the tenth calendar day of the contract expiration month (or, if the tenth calendar day is not a Frankfurt business day, the Frankfurt business day immediately following the tenth calendar day), and with a minimum issue amount of 2 billion Euros. The trading hours extend from 8:00 am to 9:15 pm Central Europe time (1:00 am to 2:15 pm Central United States time). The trading day of the third example contract extends from 8:00 am to 9:1 5 pm Central Europe time (1:00 am to 2:15 pm Central United States time). Because the corresponding physical-delivery bond futures contracts utilizes a FIFO trade matching methodology, the trade matching methodology of the example Schatz cash-settled futures contract is FIFO. The example Schatz cash-settled futures contract utilizes FT Interactive Data division of Interactive Data Corporation as the price source for cash settlement. EFP transactions are permitted.

The final settlement value (S) of the example Schatz cash-settled futures contract will be determined as:
S=(1,000 Euros)×(minimum{P₁/c₁ . . . P_{N}/c_{N}}),
where:
N is the number of Bund, Bobl, and Schatz issues fulfilling the delivery standard;
Pᵢ, i=1 to N, are market prices of each Bund or Bobl or Schatz issues fulfilling the delivery standard, where Bund and Bobl Pᵢ are quoted in points and hundredths of one point, and Schatz Pᵢ are quoted in points and halves of one hundredth of one point, with par being on the basis of 100 points in all instances.
   cᵢ, i=1 to N, are conversion factors, where each cᵢ is the price of the corresponding Bund or Bobl or Schatz issue, with a one U.S. dollar par value yielding 6.00%

While the invention has been described with specific embodiments, other alternatives, modifications and variations will be apparent to those skilled in the art. For example, while example cash-settled commodity futures contracts have been described as referenced to German government bond futures contracts , cash-settled commodity futures contracts in accordance with the principles of the present invention can include other foreign sovereign debtin addition to German, such as for example British, French, and Italian, as well as other commodities in addition to sovereign debt issues. Accordingly, it is intended to include all such alternatives, modifications, and variations set forth within the spirit and scope of the appended claims.

1. A financial instrument comprising a futures contract that enables cash settlement while simultaneously preserving the price dynamics of a physical delivery futures contract.

2. A financial instrument comprising a futures contract that provides the convenience of cash settlement and the clarity of cash-futures spreading relationships.

3. A financial instrument comprising a futures contracts having tick sizes that differ from a corresponding physical-delivery foreign government debt instrument.

4. A financial instrument comprising a futures contract that references a basket of securities corresponding to a deliverable basket for a corresponding physical-delivery foreign government debt instrument.

5. The financial instrument of claim 4 further wherein the basket of securities is identical to the deliverable basket for a corresponding physical-delivery foreign government debt instrument.

6. A financial instrument comprising a futures contract that is cash settled and obeys the same schedule for last trading day and expiration as a corresponding physical-delivery foreign government debt instrument.

7. A financial instrument comprising a futures contract that converges to a final settlement value equal to a conversion-factor-weighted price of whichever cash issue is cheapest to deliver into a corresponding physical-delivery foreign government debt instrument.

8. The financial instrument of claim 7 further wherein, in highly extreme market conditions, the futures contract and the corresponding physical-delivery foreign government debt instrument prices may diverge.

9. The financial instrument of claim 7 further wherein, in highly extreme market conditions, the futures contract of the present invention expires at a price level that minimizes unresolved cash-futures arbitrage opportunities.

10. A financial instrument comprising a futures contract that is cash-settled and mirrors a physical delivery mechanism utilized to settle a corresponding physical-delivery foreign government debt instrument.

11. The financial instrument of claim 10 further wherein Exchange Futures for Physical (EFP) transactions are permitted.

12. The financial instrument of claim 10 further wherein the futures contract utilizes a tick size different from the tick size of the corresponding physical-delivery foreign government debt instrument.

13. The financial instrument of claim 10 further wherein settlement price determination assures that the futures contract will expire at a conversion-factor-weighted price of whichever issue has the highest instantaneous repurchase agreement rate among issues in the corresponding physical-delivery foreign government debt instrument.

14. The financial instrument of claim 10 further wherein settlement price determination assures that the futures contract must expire at a price for which the minimum (notional) cash-futures basis is zero within the corresponding physical-delivery foreign government debt instrument.

15. The financial instrument of claim 14 further wherein settlement prices (S) are determined in accordance with:
S=Z ×(minimum{P₁/c₁ . . . P_{N}/c_{N}}),
where:
Z is the currency denomination price basis (in points);
N is the number of government securities issues in the contract's basket;
Pᵢ, i=1 to N, are market prices of each security in the contract's basket at the time contract expiration; and
cᵢ, i=1 to N, are conversion factors, where each cᵢ is the price at which the corresponding government security yields a given percentage to maturity.

16. The financial instrument of claim 10 further wherein the futures contract utilizes as its corresponding physical-delivery foreign government debt instrument a bond futures contract based on a long-term debt instrument issued by the Federal Republic of Germany.

17. The financial instrument of claim 16 further wherein the futures contract utilizes as its corresponding physical-delivery foreign government debt instrument a bond futures contract based on a Bundesanleihen (Bunds) notional long-term debt instrument issued by the Federal Republic of Germany.

18. The financial instrument of claim 16 further wherein the futures contract utilizes a tick size of 0.2 (20 Euros).

19. The financial instrument of claim 17 further wherein final settlement value (S) of the futures contract will be determined as:
S=Z×(minimum{P₁/c₁ . . . P_{N}/c_{N}}),
where:
Z is 1,000 Euros;
N is the number of Bund issues fulfilling the delivery standard;
Pᵢ, i=1 to N, are market prices of each Bund issue fulfilling the delivery standard, where all Pᵢ are quoted in points and hundredths of one point, with par being on the basis of 100 points; and
cᵢ, i=1 to N, are conversion factors, where each cᵢ is the price of the corresponding Bund issue, with a one U.S. dollar par value yielding 6.00% to maturity.

20. The financial instrument of claim 10 further wherein the futures contract utilizes as its corresponding physical-delivery foreign government debt instrument a bond futures contract based on a medium-term debt instrument issued by the Federal Republic of Germany.

21. The financial instrument of claim 20 further wherein the futures contract utilizes as its corresponding physical-delivery foreign government debt instrument a bond futures contract based on a Bundesobligationen (Bobls) notional medium-term debt instrument issued by the Federal Republic of Germany.

22. The financial instrument of claim 10 further wherein the futures contract utilizes as its corresponding physical-delivery foreign government debt instrument Bunds and Bobl bond futures contracts.

23. The financial instrument of claim 22 further wherein the futures contract utilizes a tick size of 0.2 (20 Euros).

24. The financial instrument of claim 22 further wherein final settlement value (S) of the futures contract will be determined as:
S=Z×(minimum{P₁/c₁ . . . P_{N}/c_{N}}),
where:
Z is 1,000 Euros;
N is the number of Bund and Bobl issues fulfilling the delivery standard;
Pᵢ, i=1 to N, are market prices of each Bund or Bobl issues fulfilling the delivery standard, where Bund and Bobl Pᵢ are quoted in points and hundredths of one point, with par being on the basis of 100 points in all instances; and
cᵢ, i=1 to N, are conversion factors, where each cᵢ is the price of the corresponding Bund or Bobl issue, with a one U.S. dollar par value yielding 6.00%.

25. The financial instrument of claim 10 further wherein the futures contract utilizes as its corresponding physical-delivery foreign government debt instrument a short-term federal debt instrument issued by the Federal Republic of Germany.

26. The financial instrument of claim 25 further wherein the futures contract utilizes as its corresponding physical-delivery foreign government debt instrument a bond futures contract based on a Bundesschatzanweisungen (Schatz) notional short-term federal debt instrument issued by the Federal Republic of Germany.

27. The financial instrument of claim 10 further wherein the futures contract utilizes as its corresponding physical-delivery foreign government debt instrument Bund, Bobl, and Schatz bond futures contracts.

28. The financial instrument of claim 27 further wherein the futures contract utilizes a tick size of 0.05 (5 Euros).

29. The financial instrument of claim 27 further wherein final settlement value (S) of the futures contract will be determined as:
S=Z×(minimum{P₁/c₁ . . . P_{N}/c_{N}}),
where:
Z is 1,000 Euros;
N is the number of Bund, Bobl, and Schatz issues fulfilling the delivery standard;
Pᵢ, i=1 to N, are market prices of each Bund or Bobl or Schatz issues fulfilling the delivery standard, where Bund and Bobl Pᵢ are quoted in points and hundredths of one point, and Schatz Pᵢ are quoted in points and halves of one hundredth of one point, with par being on the basis of 100 points in all instances.
cᵢ, i=1 to N, are conversion factors, where each cᵢ is the price of the corresponding Bund or Bobl or Schatz issue, with a one U.S. dollar par value yielding 6.00%.

30. A financial instrument comprising a futures contract that is a cash settled correspondent to a physical delivery foreign government debt instrument.

31. The financial instrument of claim 30 further wherein Exchange Futures for Physical (EFP) transactions are permitted.

32. The financial instrument of claim 30 further wherein the futures contract utilizes a tick size different from the tick size of the corresponding physical-delivery foreign government debt instrument.

33. The financial instrument of claim 30 further wherein settlement price determination assures that the futures contract will expire at the conversion-factor-weighted price of whichever issue has the highest instantaneous repurchase agreement rate among issues in the corresponding physical-delivery foreign government debt instrument.

34. The financial instrument of claim 30 further wherein settlement price determination assures that the futures contract must expire at a price for which the minimum (notional) cash-futures basis is zero within the corresponding physical-delivery foreign government debt instrument.

35. The financial instrument of claim 34 further wherein the settlement prices (S) are determined in accordance with:
S=Z×(minimum{P₁/c₁ . . . P_{N}/c_{N}}),
where:
Z is the currency denomination price basis (in points);
N is the number of government securities issues in the contract's basket;
Pᵢ, i=1 to N, are market prices of each security in the contract's basket at the time contract expiration; and
cᵢ, i=1 to N, are conversion factors, where each cᵢ is the price at which the corresponding government security yields a given percentage to maturity.

36. The financial instrument of claim 30 further wherein the futures contract utilizes as its corresponding physical-delivery foreign government debt instrument a bond futures contract based on a long-term debt instrument issued by the Federal Republic of Germany.

37. The financial instrument of claim 36 further wherein the futures contract utilizes as its corresponding physical-delivery foreign government debt instrument a bond futures contract based on a Bundesanleihen (Bunds) notional long-term debt instrument issued by the Federal Republic of Germany.

38. The financial instrument of claim 36 further wherein the futures contract utilizes a tick size of 0.2 (20 Euros).

39. The financial instrument of claim 37 further wherein final settlement value (S) of the futures contract will be determined as:
S=Z×(minimum{P₁/c₁ . . . P_{N}/c_{N}}),
where:
Z is 1,000 Euros;
N is the number of Bund issues fulfilling the delivery standard;
Pᵢ, i=1 to N, are market prices of each Bund issue fulfilling the delivery standard, where all Pᵢ are quoted in points and hundredths of one point, with par being on the basis of 100 points; and
cᵢ, i=1 to N, are conversion factors, where each cᵢ is the price of the corresponding Bund issue, with a one U.S. dollar par value yielding 6.00% to maturity.

40. The financial instrument of claim 30 further wherein the futures contract utilizes as its corresponding physical-delivery foreign government debt instrument a bond futures contract based on a medium-term debt instrument issued by the Federal Republic of Germany.

41. The financial instrument of claim 40 further wherein the futures contract utilizes as its corresponding physical-delivery foreign government debt instrument a bond futures contract based on a Bundesobligationen (Bobls) notional medium-term debt instrument issued by the Federal Republic of Germany.

42. The financial instrument of claim 40 further wherein the futures contract utilizes as its corresponding physical-delivery foreign government debt instrument Bunds and Bobl bond futures contracts.

43. The financial instrument of claim 40 further wherein the futures contract utilizes a tick size of 0.2 (20 Euros).

44. The financial instrument of claim 42 further wherein final settlement value (S) of the futures contract will be determined as:
S=Z×(minimum{P₁/c₁ . . . P_{N}/c_{N}}),
where:
Z is 1,000 Euros;
N is the number of Bund and Bobl issues fulfilling the delivery standard;
Pᵢ, i=1 to N, are market prices of each Bund or Bobl issues fulfilling the delivery standard, where Bund and Bobl Pᵢ are quoted in points and hundredths of one point, with par being on the basis of 100 points in all instances; and
cᵢ, i=1 to N, are conversion factors, where each cᵢ is the price of the corresponding Bund or Bobl issue, with a one U.S. dollar par value yielding 6.00%.

45. The financial instrument of claim 30 further wherein the futures contract utilizes as its corresponding physical-delivery foreign government debt instrument a short-term federal debt instrument issued by the Federal Republic of Germany.

46. The financial instrument of claim 45 further wherein the futures contract utilizes as its corresponding physical-delivery foreign government debt instrument a bond futures contract based on a Bundesschatzanweisungen (Schatz) notional short-term federal debt instrument issued by the Federal Republic of Germany.

47. The financial instrument of claim 30 further wherein the futures contract utilizes as its corresponding physical-delivery foreign government debt instrument Bund, Bobl, and Schatz bond futures contracts.

48. The financial instrument of claim 47 further wherein the futures contract utilizes a tick size of 0.05 (5 Euros).

49. The financial instrument of claim 47 further wherein final settlement value (S) of the futures contract will be determined as:
S=Z×(minimum{P₁/c₁ . . . P_{N}/c_{N}}),
where:
Z is 1,000 Euros;
N is the number of Bund, Bobl, and Schatz issues fulfilling the delivery standard;
Pᵢ, i=1 to N, are market prices of each Bund or Bobl or Schatz issues fulfilling the delivery standard, where Bund and Bobl Pᵢ are quoted in points and hundredths of one point, and Schatz Pᵢ are quoted in points and halves of one hundredth of one point, with par being on the basis of 100 points in all instances.
cᵢ, i=1 to N, are conversion factors, where each cᵢ is the price of the corresponding Bund or Bobl or Schatz issue, with a one U.S. dollar par value yielding 6.00%.
